(19) United States
(12) Patent Application Publication
(10) Pub. No.: US 2008/0213136 A1
(43) Pub. Date: Sep. 4, 2008

(54) CLOSED CIRCUIT AEROSOL AND VAPOR CHAMBER WITH COUNTER FLOW CONFIGURATION

(76) Inventors: Simon Caron, Montreal (CA); Hami Monsarrat-Chanon, Montreal (CA)

Correspondence Address: BCF LLP, 1100 RENE'-LE'VESQUE BLVD. WEST, 25TH FLOOR, MONTREAL, QC, H3B-5C9, CA

(21) Appl. No.: 12/030,191

(22) Filed: Feb. 12, 2008

Related U.S. Application Data
(60) Provisional application No. 60/889,531, filed on Feb. 12, 2007.

(51) Int. Cl. B01J 19/00

(52) U.S. Cl. 422/120

(57) ABSTRACT

An aerosol and vapor generation device comprises a container, a generation input for a contaminated product to be diluted in the device, a generation output, and a clean gas input. The device also includes a dilution tube in the container, with the generation input and with the clean gas input being in fluid communication with the dilution tube. The container defines a chamber, and a number of sampling ports are provided in the container such as to fluidly connect the chamber with outside units. The contaminated product and the clean gas are conveyed to the container such as to be mixed in the dilution tube and to displace therein in a first direction. The mixture then exits the dilution tube into the chamber and hits a wall of the container so as to be redirected in the chamber in a substantially counterflow direction with respect to the first direction. A sample of the mixture in the chamber can be drawn therefrom via the sampling ports.

### CROSS-REFERENCE TO RELATED APPLICATIONS

This application is a Nonprovisional application claiming priority to U.S. Provisional Patent Application No. 60/889,531, filed Feb. 12, 2007, which is herein incorporated by reference.

### FIELD OF THE INVENTION

The present invention relates to the generation of aerosols or vapors.

### SUMMARY OF THE INVENTION

It is therefore an aim of the present invention to provide a novel aerosol and vapor generation device.

It is also an aim of the present invention to provide a novel aerosol and vapor generation device used, for instance, for testing filters, for calibrating measuring apparatuses, for testing sampling media.

Therefore, in accordance with the present invention, there is provided an aerosol and vapor generation device, comprising a container, a generation input for a contaminated product to be diluted, a generation output, a clean gas input, a dilution tube in the container and in fluid communication with the generation input and with the clean gas input, a chamber defined in the container, at least sampling port adapted to fluid connect the chamber with an outside unit, wherein the contaminated product and the clean gas are adapted to be mixed in the dilution tube and to displace therein in a first direction, to exit the dilution tube in the chamber and to be redirected in the chamber in a substantially counterflow direction with respect to the first direction, and wherein a sample of the mixture in the chamber can be drawn therefrom via the sampling port.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a perspective view of an aerosol and vapor generation device according to an illustrative embodiment of the present invention and shown connected to a product emission unit;

FIG. 2 is a front perspective view of the aerosol and vapor generation device of the present invention;

FIG. 3 is a rear perspective view of the aerosol and vapor generation device of FIG. 2;

FIG. 4 is a front perspective view, similar to FIG. 2, showing in broken lines a container of the aerosol and vapor generation device for illustrative purposes;

FIG. 5 is a front perspective view, similar to FIG. 2, showing in broken lines a base of the aerosol and vapor generation device for illustrative purposes;

FIG. 6 is a front perspective view, similar to FIG. 2, shown partly exploded for illustrative purposes;

FIG. 7 is an elevation view of the aerosol and vapor generation device of FIG. 2; and

FIG. 8 is a schematic elevation flow view of the aerosol and vapor generation device of the present invention.

### DESCRIPTION OF EMBODIMENTS OF THE INVENTION

Turning to the Figures of the appended drawings, an aerosol and vapor generation device D according to an illustrative embodiment of the present invention will be described.

The generation device D generally includes a chamber for generating an aerosol or a vapor, which allows, for example, for the testing of filters, for the calibration of measuring apparatuses, for the testing of sampling media, etc.

The aerosol and vapor generation device D is adapted for use in laboratories, research centers, universities, etc.

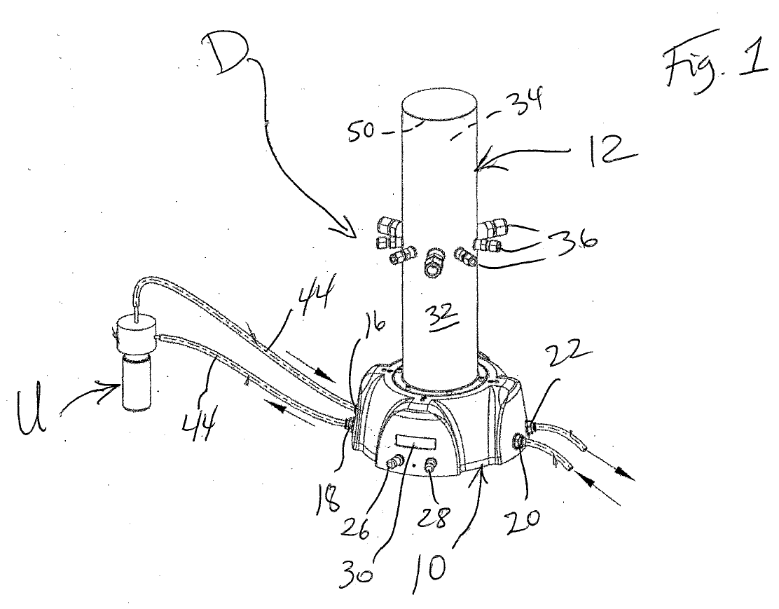

The generation device D includes mainly a base 10 and a container 12. As shown in FIG. 1, the user connects the generation device D to a product emission unit U, such as a nebulizer, an aerosol or vapor generator, or any other device capable of emitting a product of interest.

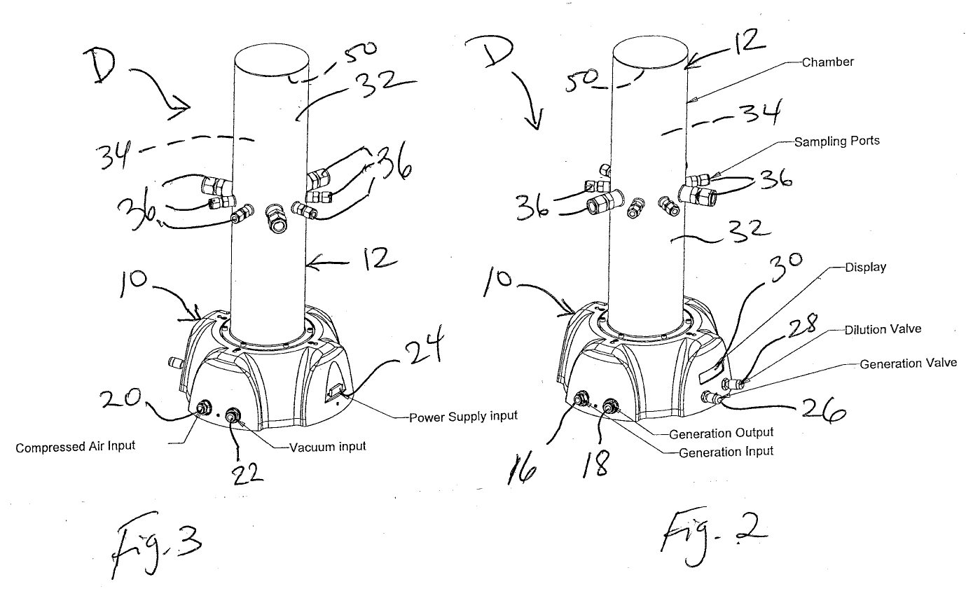

As seen in FIGS. 2 and 3, the base 10 of the generation device D includes a generation input 16, a generation output 18, a compressed air input 20, a vacuum output 22, a power supply input 24, a generation valve 26, a dilution valve 28, and a display 30.

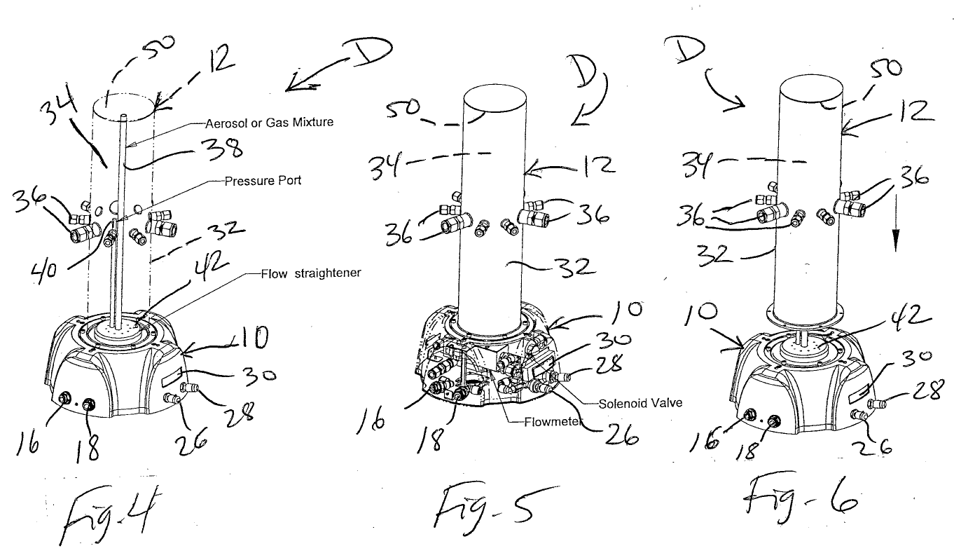

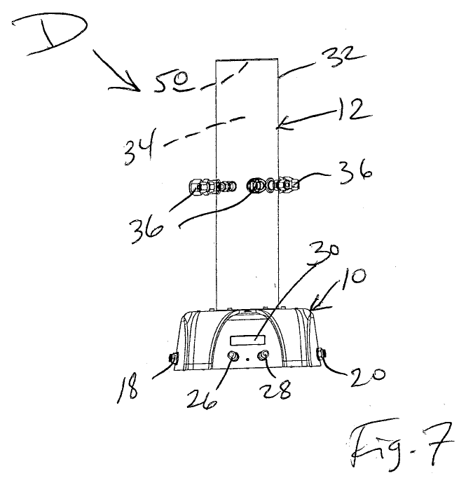

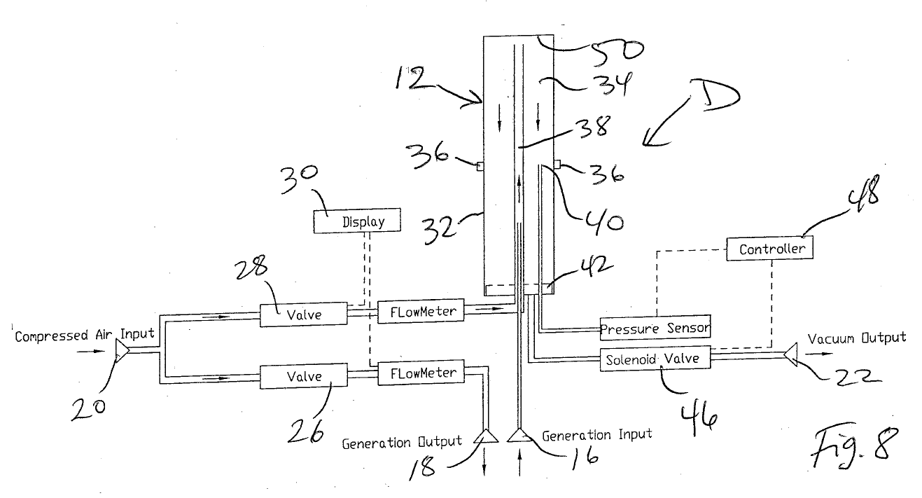

The container 12 includes a wall 32 which defines interiorly thereof a chamber 34 (best seen in FIG. 4), with a number of sampling ports 36 extending through the wall 32 for fluidly connecting the chamber 34 to outside units (not shown). As shown in FIG. 4, the container 12 also includes a dilution tube 38, a pressure port 40 and a flow straightener 42.

The generation device D is thus connected to a source of compressed air via the compressed air input 20, to a source of vacuum via the vacuum output 22, and to an electrical power supply via the input 24. The generation input and output 16 and 18 of the generation device D are connected to the product emission unit U with tubes 44 (FIG. 1).

The generation device D is adapted to dilute a contaminated gas (such as an aerosol), which is provided by the product emission unit U, in a clean gas via the dilution tube 38, as best illustrated in FIG. 8. The mixture is conveyed through the dilution 38 axially into the generation chamber 34. The flowing mixture hits an upper surface 50 of the container 12, and then flows downwardly in the chamber 12 in a stable flow.

The user can thus sample a desired amount of the mixture via the sampling port(s) 36. As also shown in FIG. 8, a valve 46 actuated by a controller 48 draws out any excess in the mixture via the vacuum output 22, such as to ensure that the pressure at the sampling ports 36 is (substantially) stable, e.g. equal to the atmospheric pressure. Pressure is measured at the pressure port 40 (located at the elevation of the sampling ports 36) and is provided to the controller 48, which then operated the solenoid valve 46 such to draw out the aforementioned fluid excess from the chamber 34.

With the present generation device D, the flow is rapidly stabilized. The device D also eliminates the jet effect and contains the contaminated elements within the chamber 34. The device D also eliminates the need for an outside pipe.

Although the present invention has been described hereinabove by way of embodiments thereof, it may be modified, without departing from the nature and teachings of the subject invention as described herein.

What I claim is:

1. An aerosol and vapor generation device, comprising a container, a generation input for a contaminated product to be diluted, a generation output, a clean gas input, a dilution tube in the container and in fluid communication with the generation input and with the clean gas input, a chamber defined in the container, at least sampling port adapted to fluid connect the chamber with an outside unit, wherein the contaminated product and the clean gas are adapted to be mixed in the dilution tube and to displace therein in a first direction, to exit the dilution tube in the chamber and to be redirected in the chamber in a substantially counterflow direction with respect to the first direction, and wherein a sample of the mixture in the chamber can be drawn therefrom via the sampling port.
